(19) United States
(12) Patent Application Publication
(10) Pub. No.: US 2015/0118141 A1
(43) Pub. Date: Apr. 30, 2015

(54) DRY-JET WET SPUN CARBON FIBERS AND PROCESSES FOR MAKING THEM USING A NUCLEOPHILIC FILLER/PAN PRECURSON

(71) Applicant: Christopher Allen Dyke, Houston, TX (US)

(72) Inventor: Christopher Allen Dyke, Houston, TX (US)

(73) Assignees: NANORIDGE MATERIALS, INCORPORATED, HOUSTON, TX (US); Brian Ronald LUCAS, Warlingham Surrey (GB)

(21) Appl. No.: 13/261,981

(22) PCT Filed: Oct. 5, 2012
(86) PCT No.: PCT/GB2012/052473

§ 371 Date: Oct. 28, 2014

Related U.S. Application Data
(60) Provisional application No. 61/627,170, filed on Oct. 6, 2011.

(51) Int. Cl. D01F 9/22; B29C 47/00; C08L 79/02; C08L 33/20; C08K 5/17

(52) U.S. Cl. CPC D01F 9/22; C08L 33/20; C08K 5/17; C08L 79/02; B29C 47/0014; B29L 2031/731
USPC 423/447.2; 525/185; 524/186; 524/502; 264/13; 264/29.2

(57) ABSTRACT

Carbon fibers made by a process using an organogel precursor that includes a nucleophilic filler and polyacrylonitrile; such a process which includes dry-jet wet spinning; and an article made from such carbon fibers.

### FIELD OF THE INVENTION

This invention is directed to: dry-jet wet spinning of carbon fiber precursors; in certain aspects, using as a precursor for making carbon fibers an organogel made with a nucleophilic filler and polyacryonitirle (PAN); and carbon fibers made with such a process.

### BACKGROUND TO THE INVENTION

Carbon fibers, often defined as a fiber with at least 92 wt % carbon, have desirable mechanical properties and are used in a very wide variety of articles, including composites, textiles, and structural parts.

In general, different precursors produce carbon fibers with different properties. Polyacrylonitirle (PAN) carbon fibers are made from a PAN precursor. Although producing carbon fibers from different precursors requires different processing conditions, the features of many processes are similar, and in these processes carbon fibers are made by a controlled pyrolysis of stabilized precursor fibers. For example, precursor fibers are first stabilized at about 200-400° C. in air by an oxidization process. The infusible, stabilized fibers are then subjected to a high temperature treatment at around 1,000° C. in an inert atmosphere to remove hydrogen, oxygen, nitrogen, and other non-carbon elements. This step is often called carbonization. Carbonized fibers can be further graphitized at an even higher temperature up to around 3,000° C. to achieve higher carbon content and higher Young's modulus in the fiber direction.

The properties of the resultant carbon/graphite fibers are affected by many factors such as crystallinity, crystalline distribution, molecular orientation, carbon content, and the amount of defects. In terms of final mechanical properties, carbon fibers can be roughly classified into ultra-high modulus (>500 GPa), high modulus (>300 GPa), intermediate modulus (>200 GPa), low modulus (100 GPa), and high strength (>4 GPa) carbon fibers. Carbon fibers can also be classified, based on final heat treatment temperatures, into type I (2,000° C. heat treatment), type II (1,500° C. heat treatment), and type III (1,000° C. heat treatment). Type II PAN carbon fibers are usually high strength carbon fibers, while many of the high modulus carbon fibers belong to type I.

Polyacrylonitrile (PAN) is a known and widely used precursor for making carbon fibers. PAN can be polymerized from acrylonitrile (AN) by commonly used radical initiators, such as peroxides and azo compounds, through the addition polymerization process. The process can be a solution polymerization process or a suspension polymerization process. Solution polymerization is often preferred so that the produced PAN solution can be used as a fiber spinning dope directly, once unreacted monomers are removed. This eliminates PAN drying and redissolving processes. The solvent has a low chain transfer coefficient in order to produce PAN with increased molecular weights. Some commonly used solvents are dimethyl sulfoxide, ZnCl₂ and NaSCN. Often, an approximate 5 mol % of co-monomers (e.g. methyl acrylate and vinyl acetate) are incorporated as internal plasticizers to reduce intermolecular interaction to improve the solubility of PAN polymer and the processability of PAN precursor fibers.

It is known that the incorporation of a co-monomer can also improve the carbon fiber mechanical properties due to increased molecular orientation in precursor fibers and the resultant carbon fibers. Some co-monomers, especially those with acidic groups (e.g. acrylic acid or itaconic acid) or acrylamide, facilitate the cyclization reaction in the stabilization step and, for that purpose, 0.4-1 mol % can be incorporated in the copolymer.

Traditional wet spinning has been widely used to produce PAN precursor fibers, as well as dry-jet wet spinning, to spin a dope with higher polymer concentrations and produce carbon fibers with better mechanical properties. In wet spinning, PAN is first dissolved into a highly polar solvent, such as dimethyl sulfoxide, dimethyl formamide, dimethyl acetamide, sodium thiocyanate or their mixtures, to form a solution of, e.g., 10-30 wt % solids. PAN solution is then filtered and extruded. The extruded PAN goes through a coagulation bath consisting of a PAN solvent and a non-solvent. Fibers are consolidated when the solvent diffuses away from the precursor. Fiber bundles are under tension in the coagulation bath to achieve the molecular alignment. The higher the concentration of the nonsolvent and the higher the temperature of the coagulation bath, the higher is the coagulation rate.

In a wet spinning process, a low coagulation rate is often preferred to prevent macrovoids extending from the outer edge to the center of the fiber. A low coagulation rate can also suppress the formation of unpreferred skin-core structure.

With a high concentration of solvent in the coagulation bath, fibers in a gel state are formed. Orientation can be achieved in this state. The PAN precursors pass though several baths with different temperatures and compositions to allow better molecular orientation in the precursor fibers. The residence time in the bath can be as short as 10 seconds.

The coagulated fibers are then washed and further stretched to remove excess solvent and increase the molecular orientation. In some aspects, fibers are drawn at a temperature between 130° C. to 150° C. by using steam, hot plates, and heated godets or glycerol baths. Further increases in tensile properties are observed as the draw ratio increases.

There are a wide variety of known systems and processes for making carbon fibers, for dry-jet wet spinning, and for dry-jet wet spinning of carbon fibers, some examples of which are in these exemplary U.S. patents and applications: U.S. Pat. Nos. 7,906,208; 7,425,368; 6,852,410; 6,290,888; 6,242,093; 5,968,432; 5,234,651; 3,996,321; 3,842,151; 3,767,756; and 3,412,191—all of which are incorporated fully herein for all purposes.

### SUMMARY OF THE INVENTION

In some embodiments the invention relates to a precursor for making carbon fibers, the precursor comprising an organogel made with a nucleophilic polymer filler and polyacrylonitrile material (PAN).

In some embodiments the organogel is a thermoreversible organogel. It may be provided in a form loaded into or dissolved in a polar solvent e.g. dimethyl sulfoxide (DMSO).

In a further embodiment the invention provides a process for making carbon fibers, the process comprising:

with spinning apparatus, spinning filaments from a spinning dope with a precursor as defined above to produce spun filaments;

drawing the spun filaments producing drawn filaments;

stabilizing the drawn filaments producing stabilized filaments; and

carbonizing the stabilized filaments producing carbon fibers.

In embodiments where the organogel is a thermoreversible organogel, the above process may be a dry-jet wet spinning process further comprising:

providing a spinning head equipped with a multi-hole spinneret and spaced apart from a bath with an air gap;

heating the spinning head and the spinneret with a heating element to a temperature above the gel formation temperature of the material;

introducing the organogel into the spinning head as a flowable material, the organogel being above its gel formation temperature; and

allowing the material exiting the spinning head to cool below the gel transition temperature so that a gel begins to form in the air gap between the spinning head and the bath, the sol-gel transition temperature being sufficiently low that the material is in the liquid state in the spinning head, while sufficiently high to form a gel as the material leaves the spinning head.

In the above embodiments the fibers may be drawn in a gelled state and before phase inversion or coagulation.

Embodiments of the invention also relate to processes and carbon fibers made with a dry-jet wet spinning process that uses as a precursor an organogel made with a nucleophilic polymer filler and polyacrylonitrile (PAN) or a copolymer or terpolymer thereof; and articles e.g. carbon fiber reinforced made from such carbon fibers.

The present invention, in some embodiments, discloses such processes in which the

Certain processes according to the present invention include:

spinning filaments from the PAN/filler precursor;

drawing the spun filaments;

stabilizing the drawn filaments; and

carbonizing the stabilized filaments;

(and, optionally, graphitizing the carbonized filaments) producing carbon fibers. Multiple coagulating steps, multiple drawing steps and/or multiple carbonizing steps may be employed.

### BRIEF DESCRIPTION OF THE DRAWINGS

How the invention may be put into effect will be described below, by way of example only, with reference to the accompanying drawings, in which similar parts may be referred to by the same reference numerals, and:

FIG. 1 presents in schematic form a summary of a process according to the present invention.

FIG. 2 presents in schematic form a summary of a process according to the present invention.

### DESCRIPTION OF PREFERRED EMBODIMENTS

As regards the polyacrylonitrile component of the organogel, “PAN” includes homopolymers and copolymers of polyacrylonitrile with one or more than one co-monomer (e.g. a terpolymer), including, but not limited to, PAN/MA (PAN/methylacrylate) and PAN/MA/IA (PAN/methyl acrylate/itaconic acid). As explained above, up to about 5 mol % of co-monomers (e.g. methyl acrylate and vinyl acetate) may be incorporated as internal plasticizers to reduce intermolecular interaction, to improve the solubility of PAN polymer and the processability of PAN precursor fibers and to improve the carbon fiber mechanical properties due to increased molecular orientation in precursor fibers and the resultant carbon fibers. Some co-monomers, especially those with acidic groups (e.g. acrylic acid or itaconic acid) or acrylamide, facilitate the cyclization reaction in a subsequent stabilization step and, for that purpose, 0.4-1 mol % can be incorporated in the copolymer. As regards molecular weight, gel formation and gel spinning have been reported with linear PAN of ultra-high molecular weight, see U.S. Pat. No. 4,883,628 (Kwock) but only with PAN having a weight average molecular weight >500,000 and in embodiments 1,000,000-4,000,000 e.g. 1,500,000-2,500,000 and with a relatively narrow range of concentrations or solid loadings of PAN in the selected solvent or dispersant e.g. 2-15 wt % and with recommended temperatures at which the gel is to be extruded of 130-200° C. which is undesirably close to the boiling points of the solvent or dispersant e.g. DMSO. The molecular weights of the PAN homopolymer or copolymers used herein may in some embodiments be above those used for the forming of conventional textile fibers but less than the ultra-high molecular weight grades employed by Kwock e.g. weight average molecular weights of 80,000-150,000, in many embodiments about 100,000. The PAN homopolymer or copolymers with molecular weights in this range may not spontaneously form gels when dissolved or dispersed in the solvent or dispersant, but in that case may be induced to form gel by the nucleophilic polymer filler, e.g. where that filer is a semi-rigid polymer that on extrusion into fibers becomes oriented in the fiber direction. Use of lower molecular weight grades of PAN enables higher solid loadings of PAN in the solvent or dispersant.

The nucleophilic polymer filler may be an organic compound with a nucleophilic subunit, such as a carboxylic acid containing subunit, an alcohol subunit, a phenol-containing subunit, an amine-containing subunit, and/or a thiol-containing subunit and/or a combination of two or more of these. Particular nucleophilic polymer fillers are based on nitrogen linked to aryl e.g. phenyl or substituted phenyl or are based on primary and secondary aliphatic amino groups. For example, the filler may be polyaniline (PANI) or an aliphatic polyether diamine, e.g., commercially available JEFFAMINE (Trademark) aliphatic polyether diamines. Such diamines may have primary or secondary amino groups, may have methyl groups adjacent to the amino groups and may have repeating oxyalkylene units e.g. oxyethylene units, oxypropylene units, oxytetramethylene units e.g a propylene oxide capped polyethylene glycol. For example they may be of may be of the formula:

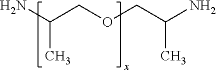

where x may be from 2 to 100, e.g. 30-60 giving molecular weights in the hundreds, thousands or even above. Embodiments of the present organogels may incorporate PAN and PANI and PAN copolymers including comonomers having acidic groups e.g. PAN/MA and PANI and PAN/MA/IA and PANI, the latter variants as mentioned above facilitating the cyclization reaction in subsequent stabilization.

In some embodiments, an organogel is made by adding polymeric PANI (polyaniline in emeraldine base form) to PAN (polyacrylonitrile in powder form), including, optionally, copolymers of PAN (such as PAN/MA and PAN/MA/IA). The components may be combined by dissolving both materials in a highly polar solvent, e.g., DMF, DMSO, OR DMAC (dimethyl acetamide). The resulting organogel is a thermoreversibie organogel.

In certain particular embodiments an organogel is produced with PANI and PAN, PAN/MA or PAN/MA/IA for introduction to a spinning head that has 0.25-2 wt % e.g. 0.5-1.0 wt % PANI in PAN, PAN/MA or PAN/MA/IA with a total of 10 to 30 wt % solids loading in a polar solvent, e.g., DMSO solvent (dimethylsulfoxide). “Solids loading” is the amount in weight of material in the spinning dope other than solvent.

In certain embodiments gel formation is reversed by heating the organogel material. In certain aspects, the solution-gel transition temperature is decreased by lowering the loading of the filler, e.g., PANE. Therefore the loading of the filler, e.g., PANT, can be adjusted e.g. within the 0.5-1 wt % range to increase or decrease the sol-gel transition temperature. In certain embodiments, the sol-gel transition temperature should be sufficiently low so that the material is in the liquid state in the spinning head, while sufficiently high to form a gel as the material leaves the spinning head e.g. about 70-less than 130° C. e.g. about 80-90° C. e.g. about 80° C. To facilitate reversion to the gel state, extrusion in some embodiments is at a temperature that is close to the sol-gel transition point so that virtually as soon as the fibers are extruded into lower temperature air they start to revert to the gel state. The applicants have observed in some embodiments sol-gel transition temperatures varying from 70 to 100° C. The material may be warmed above this temperature and poured into the spinning head. The spinning head and spinneret, composed of metal, may then be held at a temperature slightly above the transition temperature (varies depending on composition of material). Once the solution is forced out of the spinning head, it enters an air gap which is a zone between spinning head and a first downstream treatment station e.g. a coagulation bath. The air gap is maintained at ambient temperature and pressure. The material leaves the heat source (or spinning head) and cools to a temperature below the sol-gel transition temperature. In effect, the material transitions from solution to gel in the air gap as it cools.

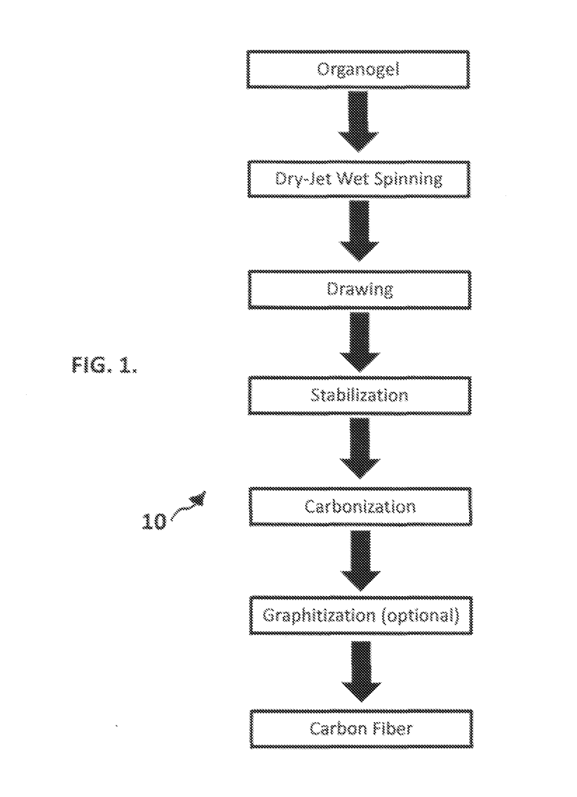

FIG. 1 shows schematically steps in a process 10 according to the present invention for producing carbon fibers. An organogel (“Organogel”) may be made with PAN and with a nucleophilic polymer filler. This organogel with a solvent provides a “spinning dope” for a dry-jet wet spinning process (“Dry-Jet Wet Spinning”) that produces spun filaments made from the organogel. The dry-jet wet spinning includes a coagulation bath or baths to remove solvent from the filaments and to facilitate the formation of fibers.

The filaments are drawn (“Drawing”) or stretched to achieve desired molecular alignment of PAN and nucleophilic polymer filler and to decrease the spacing.

The drawn fiber is then stabilized (“Stabilization”). Stabilization includes cyclization, dehydrogenation and oxidation of the oriented PAN polymer. Stabilization can include placing the fibers under tension while they are heated, e.g., in air.

The stabilized fibers are converted (carbonized) to carbon fibers by pyrolysis of the stabilized fiber (“Carbonization”) with a high temperature treatment in an inert atmosphere; and then, optionally, graphitized (“Graphitization”) using heating temperatures higher than those of the carbonization step.

The gel in fluid form is introduced into a spinning head equipped with a multi-hole spinneret used in a dry-jet wet spinning process. The organogel is introduced as a flowable non-gelled fluid material. The organogel is preheated by heating the spinning head and the spinneret with a heating element to a temperature above the material's gel formation temperature. Upon exiting the spinning head, the material's temperature is lowered below the gel transition temperature and a gel begins to form in the air in an air gap between the head and a bath. By gelling the organogel before coagulation of the material, the linear jet velocity (rate of polymer extrusion from the spinning head) of the material may be increased and drawing of the fibers during the spinning stage may be possible. This increase in linear jet velocity and ability to draw fibers during the spinning operation facilitates increased polymer alignment, i.e., the extent of orientation of PAN in the fiber longitudinal direction. Increased linear jet velocity and drawing also decreases the percentage of macrovoids in the fiber. As the material leaving the spinning head is gelled and before phase inversion or coagulation, drawing in the coagulation bath in the gel state is possible.

In some known processes, stabilization can be the slowest and, therefore, most inefficient step in the overall fiber making process. In these processes, the fibers are heated in air while being tensioned with three reactions occurring at this stage—cyclization, oxidation, and dehydrogenation—all of which are exothermic and which can cause polymer degradation if heating is too rapid. If fibers are not oriented properly, e.g., if fibers are in a helical or random coil conformation and not in a planar zigzag conformation, the desired cyclization can terminate after four or five repeat units leading to undesirable polymer scission. “Repeat units” are the successively linked subunits in the PAN polymer.

Use of an organogel according to the present invention in a fiber production process reduces the residence time of the fiber in the stabilization process in several ways, including decreasing stabilization temperatures and times. In certain embodiments, this is accomplished by initiating cyclization (ladder polymer formation of PAN) at a relatively lower temperature.

In certain embodiments of the present invention, fibers produced by a spinneret using an organogel according to the present invention are heated at a rate of 1 to 2° C. per second from room temperature up to a maximum temperature of between 220° C. to 300° C. in a stabilization furnace. The maximum temperature varies depending on the particular PAN fiber precursor and the nucleophilic polymer filler. This is determined by the exothermic peak maximum temperature of the drawn PAN fiber.

Use of an organogel according to the present invention using a nucleophilic polymer filler as described above and a relatively low loading of such fillers according to the present invention, can cause a desired ionic cyclization to occur. This decreases stabilization time and stabilization temperature (as compared′ to certain known processes which do not use such fillers). Using nucleophilic fillers according to the present invention can produce a more efficient cyclization. It is believed (without being held or bound to any particular theory or mechanism) that desired cyclization is initiated inter-molecularly, not intra-molecularly, giving cyclization over a greater number of repeat units. In one particular case, starting with a PAN/MA copolymer powder and making carbon fibers, the maximum stabilization temperature was about 290° C. When nucleophilic fillers were added to the PAN/MA, the exothermic maximum was substantially reduced—in one case to about 270° C. (using a 0.5 wt % loading of PANI) and to about 245° C. (using a 0.5 wt % (weight percent) loading of commercially available JEFFAMINE (Trademark) ED-600 aliphatic polyether daimine). JEFFAMINE 600 is an aliphatic polyether diamine derived from a propylene oxide-capped polyethylene glycol of approximate MW 600 and of the formula shown below where x, y and z are selected to give the indicated molecular weight. Such a lowering of the cyclization temperature can decrease the stabilization time and can result in lower overall fiber production costs.

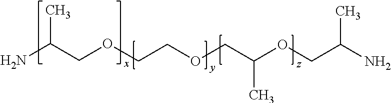

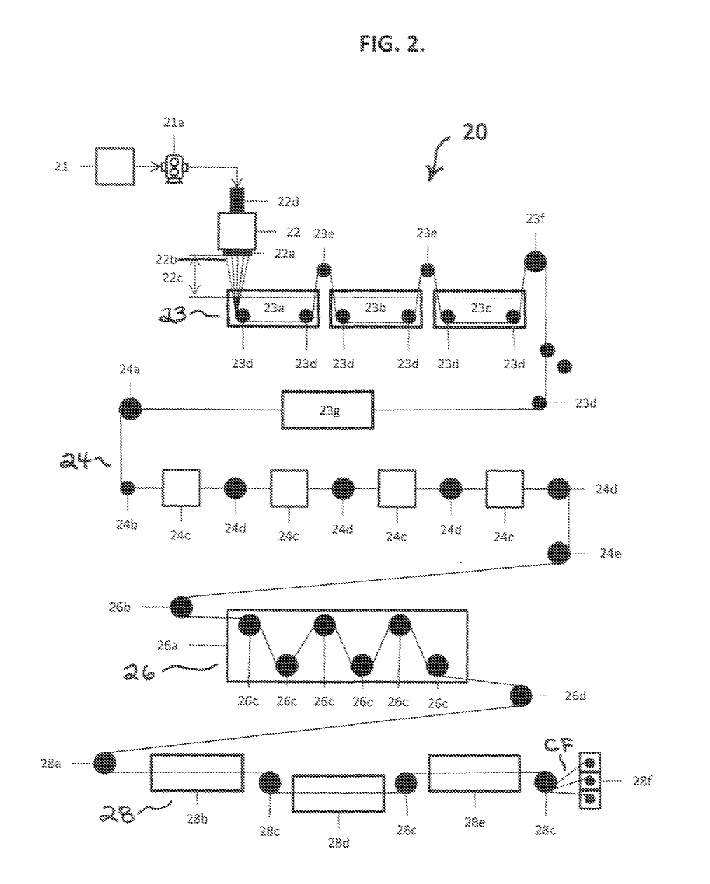

FIG. 2 presents schematically a process 20 according to the present invention. Spinning dope according to the present invention is heated in a vessel 21 and transferred to a spinning head 22. The spinning solution passes from the spinning head 22 to form filaments 22b. These filaments 22b pass through an air gap to a coagulation system 23 and then to a drawing system 24. From the drawing system 24, the fibers are introduced to a stabilization system 26. Following stabilization, the fibers are carbonized in a carbonization system 28 whose output is carbon fibers CF.

A pump system 21a pumps spinning dope from the heated vessel 21 to a spinning head 22. In one particular embodiment, the spinning dope is a mixture of PANI/PAN/DMSO. The PANI is a 0.5 to 1.0 wt % loading in PAN while the overall wt % solids loading in DMSO is typically 20 to 30 wt %. The spinning dope is pumped at an approximate rate of 100 mL/min and at a temperature of 80° C.

Spun filaments 22b exit the spinning head 22 passing through a multi-hole spinneret 22a and flow into an air gap 22c which is maintained at room temperature, e.g., about 25° C. The filaments are cooled in the air gap and convert from a solution to a gel. The filaments are forced through the spinneret 22a by a plunger system 22d.

The resulting fibers pass through three coagulation baths 23a, 23b, 23c with guide rollers 23d in the baths and drawing motors 23e and 23f above the baths. The fibers are then fed from a take-up roller 23g to a payout spool 24a of the drawing system 24. The coagulation baths contain a mixture of the polar spinning solvent and the non-solvent (e.g., water). The temperature of each bath is maintained at approximately room temperature to decrease the rate of diffusion of the polar spinning solvent. The RPM of the drawing motors 23e and the take-up roller 23f is adjusted to give a draw ratio of between 4 and 9. The fiber is then passed through a drier to the drawing system 24.

From the payout spool 24a, the fibers are pulled around a guide roller 24b and through a series of heating blocks 24c by heated drawing rollers 24d. The drawn fiber is then collected on a take-up spool 24e. In one aspect, each drawing apparatus has a heated godet drawing roller 24d and a hot plate shoe 24c. The temperature of the heating blocks and heated rollers is between 100° C. and 180° C. The RPM of the rollers is adjusted to give a draw ratio of typically between 5 and 12.

A payout spool 26h in the stabilization system 26 receives the fibers from the take-up roller 24e in the drawing system 24. The fibers are tensioned by tensioning stations 26c through a stabilization furnace 26a. The temperature of the furnace is increased by 1 to 2° C./min to a maximum temperature of between 200 and 300° C. The heating rate and maximum temperature is adjusted to avoid degradation of the PAN due to exothermic self-heating. The maximum temperature depends on the PAN precursor and is reduced by the addition of nucleophilic fillers (as described herein and below).

Tensioning is controlled by adjusting the rate of rotation, RPMs, of the spools at each tensioning station such that entropic shrinkage of the fiber is mitigated and the fiber is drawn in the furnace to a maximum of 30% strain

Pyrolysis of the stabilized fiber converts the PAN precursor to carbon fibers. Non-carbon atoms are driven off in the form of small organics, such as HCN and N₂ and, by heating the fibers in the carbonization/graphitization furnace system 28. A payout system 28a receives the fibers from the stabilization system 26.

The stabilized fibers are heat-treated in an inert atmosphere to a maximum temperature of 800° C. in a low temperature carbonization furnace 28b. The fibers are drawn through the furnace by a heated tensioning roller 28c so as to heat the fibers at a maximum rate of 5° C./min. The fibers are then drawn by a tensioning roller 28c through a high temperature furnace 28d with a maximum temperature of 1600° C. This gives carbon fiber with maximum tensile strength.

If maximization of modulus is required, the carbon fiber is additionally graphitized. Graphitization may be conducted by drawing the carbon fiber through an ultra-high temperature furnace 28e by a heated tensioning roller 28c. The carbon fibers are finally collected on spools by a winding system 28f.

The finished carbon fibers made by this embodiment of the process 20 are 95-98% carbon. The carbon fibers may be 5 μm in diameter with an approximate weight per length value of 0.446 g/m.

1.-33. (canceled)

34. A precursor for making carbon fibers comprising an organogel made with a polyacrylonitrile material and a nucleophilic polymer filler.

35. The precursor of claim 1, wherein the organogel is a thermoreversible organogel.

36. The precursor of claim 35, wherein the organogel comprises a polyacrylonitrile material having a weight average molecular weight which is one of: 80,000-150,000 about 100,000.

37. The precursor of claim 35, wherein the organogel has a sol-gel transition temperature which is one of: 70-130° C.; 80-90° C.; and about 80° C.

38. The precursor of claim 34, wherein the polyacrylonitrile is a homopolymer.

39. The precursor of claim 34, wherein the polyacrylonitrile is a copolymer or terpolymer of acrylonitrile with at least one polymerizable monomer having an alkenyl group and one or two carboxylic acid or ester groups per molecule.

40. The precursor of claim 34, wherein the polyacrylonitrile is one of PAN/MA (PAN/methylacrylate) and PAN/MA/IA (PAN/methyl acrylate/itaconic acid).

41. The precursor of claim 34, wherein the nucleophilic polymer filler is an organic compound with a carboxylic acid unit, an alcohol unit, a phenol unit, an amine unit, a thiol unit, polyaniline (PANI), an aliphatic polyether diamine, polyaniline in emaraldine base form, and/or other nucleophilic subunit and/or a combination of two or more of these.

42. The precursor of claim 34, comprising a total of 10 to 30 wt % solids loading in a polar solvent. 1

43. The precursor of claim 34, wherein the nucleophilic polymer filler has 0.5 to 1.0 wt % PANI in PAN or a copolymer thereof.

44. A process for making carbon fibers, the process comprising:
with spinning apparatus, spinning filaments from a spinning dope with a precursor as defined in any preceding claim to produce spun filaments;
drawing the spun filaments producing drawn filaments;
stabilizing the drawn filaments producing stabilized filaments; and
carbonizing the stabilized filaments producing carbon fibers.

45. The process of claim 44, wherein the organogel is a thermoreversible organogel and the process is a dry-jet wet spinning process further comprising:
providing a spinning head equipped with a multi-hole spinneret and spaced apart from a bath with an air gap; heating the spinning head and the spinneret with, a heating element to a temperature above the gel formation temperature of the material;
introducing the organogel into the spin ing head as a flowable material, the organogel being above its gel formation temperature; and
allowing the temperature of material exiting the spinning head to lower below the gel transition temperature so that a gel begins to form in the air gap between the spinning head and the bath, the sol-gel transition temperature being sufficiently low that the material is in the liquid stale in the spinning head, while sufficiently high to form a gel as the material leaves the spinning head.

46. The process of claim 44, wherein the fibers are drawn in a gelled state and before phase inversion or coagulation.

47. The process of claim 44, further comprising bathing the spun filaments in at least one coagulation bath or in multiple coagulation baths removing solvent from the spun filaments to facilitate fiber formation.

48. The process of claim 47, wherein the fibers are drawn during phase inversion or coagulation and wherein after phase inversion or coagulation the fibers are stabilized by heating, the temperature being increased by 1-2° C./min to a maximum between 200 and 300° C.

49. The process of claim 44, wherein the stabilization is done at a stabilization temperature and the process further comprising controlling the stabilization by controlling the loading in the precursor of the nucleophilic filler.

50. The process of claim 44, further comprising graphitizing the carbon fibers after carbonizing.

51. Carbon fibers made by a process comprising
stabilizing produced filaments made from a precursor of PAN material with a nucleophilic filler,
the stabilizing done at a stabilizing temperature,
controlling the stabilizing temperature by controlling loading of the nucleophilic filler in the precursor, and
making the filaments into carbon fibers.

52. The carbon fibers of claim 51 wherein the process further includes making the carbon fibers into an article.
